(19) United States
(12) Patent Application Publication
(10) Pub. No.: US 2019/0391290 A1
(43) Pub. Date: Dec. 26, 2019

(54) Dipole Source

(71) Applicant: PGS Geophysical AS, Oslo (NO)

(72) Inventor: Stig Rune Lennart Tenghamn, Houston, TX (US)

(73) Assignee: PGS Geophysical AS, Oslo (NO)

(21) Appl. No.: 16/446,527

(22) Filed: Jun. 19, 2019

Related U.S. Application Data
(60) Provisional application No. 62/687,279, filed on Jun. 20, 2018.

(51) Int. Cl. G01V 1/38; G01V 1/145; G01V 1/09; G01V 1/143

(52) U.S. Cl. CPC G01V 1/3861; G01V 1/143; G01V 1/09; G01V 1/145

(57) ABSTRACT

Disclosed are dipole sources and associated methods. An example system may include a dipole source a first marine seismic vibrator and a second marine seismic vibrator. The first marine seismic vibrator may include two or more sound radiating surfaces. The second marine seismic vibrator may also include two or more sound radiating surfaces. A relative position of the second marine seismic vibrator to the first marine seismic vibrator may be fixed. The first marine seismic vibrator may be positioned above the second marine seismic vibrator in a towing configuration. The system may further include a control system operable to control the dipole source such that the first marine seismic vibrator is operating substantially 180° out of phase with the second marine seismic vibrator.

### CROSS-REFERENCE TO RELATED APPLICATIONS

The present application claims the benefit of U.S. Provisional Application No. 62/687,279, filed Jun. 20, 2018, entitled “Dipole Source,” the entire disclosure of which is incorporated herein by reference.

### BACKGROUND

Techniques for marine surveying include marine seismic surveying, in which geophysical data may be collected from below the Earth's surface. Marine seismic surveying has applications in mineral and energy exploration and production to help identify locations of hydrocarbon-bearing formations. Marine seismic surveying typically may include towing a seismic source below or near the surface of a body of water. One or more “streamers” may also be towed through the water by the same or a different vessel. The streamers are typically cables that include a plurality of sensors disposed thereon at spaced apart locations along the length of each cable. Some seismic surveys locate sensors on ocean bottom cables or nodes in addition to, or instead of, streamers. The sensors may be configured to generate a signal that is related to a parameter being measured by the sensor. At selected times, the seismic source may be actuated to generate, for example, acoustic energy that travels downwardly through the water and into the subsurface formations. Acoustic energy that interacts with interfaces, generally at the boundaries between layers of the subsurface formations, may be returned toward the surface and detected by the sensors on the streamers. The detected energy may be used to infer certain properties of the subsurface formations, such as structure, mineral composition and fluid content, thereby providing information useful in the recovery of hydrocarbons.

It is well known that as pressure waves travel through water and through subsurface formations, higher frequency pressure waves may be attenuated more rapidly than lower frequency pressure waves, and consequently, lower frequency pressure waves can be transmitted over longer distances through water and geological structures than higher frequency pressure waves. In addition, the lowest frequency range can be important for deriving the elastic properties of the subsurface by seismic full wave field inversion (FWI). Accordingly, there has been a need for powerful low frequency marine sound sources operating in the frequency band of 1 hertz to 100 hertz (“Hz”) and, as low as 2 to 3 octaves below 6 Hz. However, generation of low frequency pressure wave fields from seismic sources based on volume injection, such as air guns, marine vibrators, benders, etc., hereinafter referred to as “monopole-type sources,” may be limited by a ghost function of the monopole-type source, in which the pressure wave fields that propagate toward the water surface are reflected at the water-air interface. These reflected waves, commonly referred to as “ghosts,” have the opposite polarity of the up-going waves and propagate toward the water bottom. The ghosts interfere with the pressure waves from the sound source going downwards toward the bottom and act as a filter on the reflected wave field. The amplitude spectrum of a monopole-type ghost filter G(ω)=1−e^{-iωτ} (with τ vertical delay time) is sine shaped with amplitude zero at k*water_velocity/(2*source_depth) Hz (and maxima in the middle between two zero crossings) for k=0, 1, 2, etc. Thus, the amplitude of the monopole-type source may approach zero at 0 Hz.

### BRIEF DESCRIPTION OF THE DRAWINGS

These drawings illustrate certain aspects of some of the embodiments of the present disclosure and should not be used to limit or define the disclosure.

FIG. 1 illustrates an example embodiment of a marine seismic survey system using a marine seismic vibrator.

FIG. 2A illustrates an example embodiment of generation of acoustic waves by a dipole source.

FIG. 2B illustrates another example embodiment of generation of acoustic waves by a dipole source.

FIG. 3 illustrates an example embodiment of a dipole source.

FIG. 4 illustrates another example embodiment of a dipole source.

### DETAILED DESCRIPTION

Embodiments may be directed to dipole sources and associated methods. At least one embodiment may be directed to a dipole source used for marine seismic data acquisition systems, wherein the dipole source may generate an up-going wave and a down-going wave with opposite polarity. The dipole source may include a first marine seismic vibrator having at least two vibratory surfaces and a second marine seismic vibrator having at least two vibratory sources. A control system may operate the first marine seismic vibrator and second marine seismic vibrator 180° out phase with one another. Embodiments may include fixing the first marine seismic vibrator and the second marine seismic vibrator to one another so that up-going waves produced by the first marine seismic vibrator has a reverse polarity with down-going waves produced by the second marine seismic vibrator.

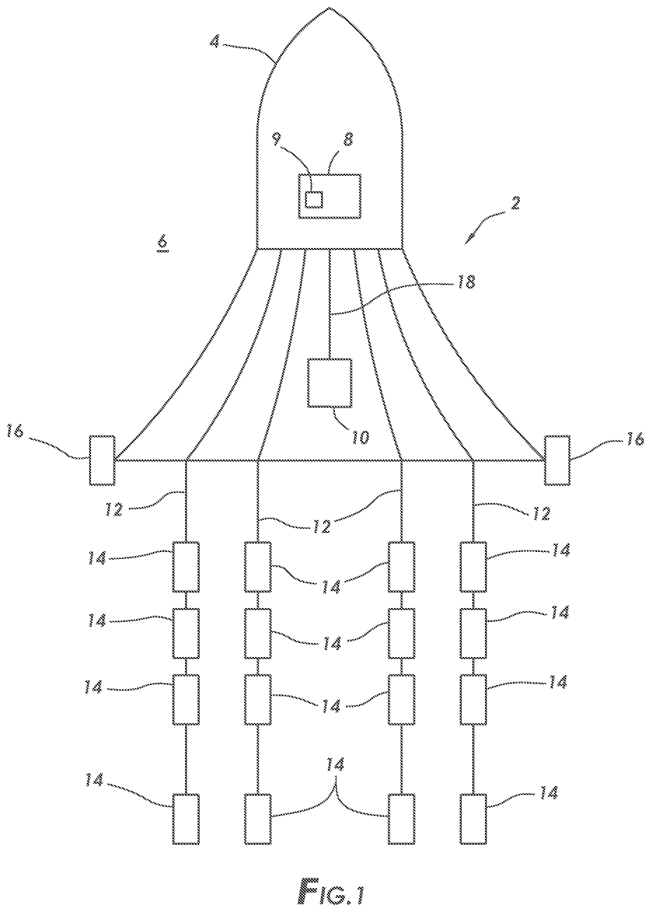

FIG. 1 illustrates a marine seismic survey system 2 in accordance with example embodiments. Marine seismic survey system 2 may include a survey vessel 4 that moves along the surface of a body of water 6, such as a lake or ocean. The survey vessel 4 may include thereon equipment, shown generally at 8 and collectively referred to herein as a “recording system.” The recording system 8 may include devices (none shown separately) for detecting and making a time indexed record of signals generated by each of seismic sensors (explained further below) and for actuating a dipole source 10 at selected times. The recording system 8 may also include a control system 9 for controlling operation of the dipole source 10. The control system 9 may be a component of the recording system 8 as shown on FIG. 1 or the control system 9 may be a separate component. The recording system 8 may also include devices (none shown separately) for determining the geodetic position of the survey vessel 4 and the various seismic sensors.

As illustrated, the survey vessel 4 may tow sensor streamers 12. The sensor streamers 12 may be towed in a selected pattern in the body of water 6 by the survey vessel 4 or a different vessel. As illustrated, the sensor streamers 12 may be laterally spaced apart behind the survey vessel 4. “Lateral” or “laterally,” in the present context, means transverse to the direction of the motion of the survey vessel 4. The sensor streamers 12 may each be formed, for example, by coupling a plurality of streamer segments (none shown separately). The sensor streamers 12 may be maintained in the selected pattern by towing equipment 16, such as paravanes or doors that provide lateral force to spread the sensor streamers 12 to selected lateral positions with respect to the survey vessel 4. The sensor streamers 12 may have a length, for example, in a range of from about 2,000 meters to about 12,000 meters or longer. The configurations of the sensors streamers 12 on FIG. 1 is provided to illustrate an example embodiment and is not intended to limit the present disclosure. It should be noted that, while the present example, shows four of the sensor streamers 12, the present disclosure is applicable to any number of sensor streamers 12 towed by survey vessel 4 or any other vessel. For example, in some embodiments, more or less than four of the sensor streamers 12 may be towed by survey vessel 4, and the sensor streamers 12 may be spaced apart laterally, vertically, or both laterally and vertically.

The sensor streamers 12 may include seismic sensors 14 thereon at spaced apart locations. The seismic sensors 14 may be any type of seismic sensors known in the art, including hydrophones, geophones, particle velocity sensors, particle displacement sensors, particle acceleration sensors, or pressure gradient sensors, for example. By way of example, the seismic sensors 14 may generate response signals, such as electrical or optical signals, in response to detecting acoustic energy emitted from the dipole source 10 after the energy has interacted with the subsurface formations (not shown) below the water bottom. Signals generated by the seismic sensors 14 may be communicated to the recording system 8. While not illustrated, the seismic sensors 14 may alternatively be disposed on ocean bottom cables or subsurface acquisition nodes in addition to, or in place of, sensors streamers 12.

In accordance with example embodiments, a geophysical data product indicative of certain properties of the one or more subsurface formations (not shown) may be produced from the detected acoustic energy. The geophysical data product may include acquired and/or processed seismic data and may be stored on a non-transitory, tangible, computer-readable medium. The computer-readable medium may include any computer-readable medium that is tangible and non-transitory, including, but not limited to, volatile memory, such as random access memory (RAM) and non-volatile memory, such as read-only memory (ROM), flash memory, hard disc drives, optical disks, floppy discs, and magnetic tapes. In some embodiments, the detected acoustic energy may be processed to generate a seismic image that may be stored on a non-transitory, tangible, computer-readable medium to form the geophysical data product. The geophysical data product may be produced offshore (e.g., by on a vessel) or onshore (e.g., at a facility on land) either within the United States and/or in another country. Specifically, embodiments may include producing a geophysical data product from at least the measured acoustic energy and storing the geophysical data product on a non-transitory tangible computer-readable medium suitable for importing onshore. If the geophysical data product is produced offshore and/or in another country, it may be imported onshore to a facility in, for example, the United States or another country. Once onshore in, for example, the United States (or another country), further processing and/or geophysical analysis may be performed on the geophysical data product.

As illustrated in FIG. 1, the survey vessel 4 or a different vessel may further tow dipole source 10. Although only a single dipole source 10 is shown, it should be understood that more than one dipole source 10 may be used as desired for a particular application. Where more than one of the dipole source 10 is used, they may be towed by the survey vessel 4 or different survey vessels, for example. A source cable 18 may couple the dipole source 10 to the survey vessel 4. The source cable 18 may take drag forces and also may include electrical conductors (not shown separately) for transferring electrical current from the recording system 8 on the survey vessel 4 to the dipole source 10. The source cable 18 may also include signal cables or fibers for transmitting signals to and/or from the dipole source 10 to the recording system 8. The source cable 18 may also include strength members (not shown separately) for transmitting towing force from the survey vessel 4 to the dipole source 10. The source cable 18 may also contain conductors for transmitting air to the dipole source 10 for pressure compensation, for example. The source cable 18 may have a length in a range of from about 200 meters to about 2,000 meters or longer, for example. In some embodiments, the source cable 18 may be relatively parallel to the surface of the body of water 6, while in other embodiments, the source cable 18 may utilize depth control mechanisms, for example, to locate more than one dipole source 10 at a plurality of different depths.

In contrast to impulsive-type sources which transmit energy during a very limited amount of time, the dipole source 10 may have a reduced environmental impact due the distribution of energy over time. In particular, the dipole source 10 may have a reduced peak amplitude of the transmitted seismic signal during a seismic survey with little or no reduction in the data quality. For example, by using a dipole source 10 with, for example, a five-second sweep, instead of an impulsive-type source such as an air gun, the peak amplitudes can be reduced by as much as 30 dB or even more. If pseudo-noise source sequences are used to not only spread out the energy over time but also the frequency over time, the peak amplitudes may be reduced by another 20 dB or even more. In some embodiments, the peak amplitudes may be in the range of about 10 dB to about 40 dB.

In some embodiments, the control system 9 may operate the dipole source 10 as a low frequency source. For example, the dipole source 10 may operate at frequencies of less than about 25 Hertz (“Hz”). In some embodiments, the dipole source 10 may operate at a frequency in a range of from about 0.1 Hz to about 25 Hz, about 0.1 Hz to about 10 Hz, or about 0.1 Hz to about 6 Hz. Those of ordinary skill in the art, with the benefit of this disclosure, should be able to select an appropriate frequency for operation of the dipole source 10. The control system 9 may include hardware and software that operate to control dipole source 10. For example, control system 9 may include a processor (e.g., microprocessor), memory, and interfaces, among other components. In some embodiments, processor may include any type of computational circuit, such as a microprocessor, a complex instruction set computing (CISC) microprocessor, a reduced instruction set computing (RISC) microprocessor, a very long instruction word (VLIW) microprocessor, a digital signal processor (DSP), or any other type of processor, processing circuit, execution unit, or computational machine. It should be understood that embodiments of the control system 9 should not be limited to the specific processors listed herein. In some embodiments, the control system 9 use iterative learning control characterizations to control a phase, generate a repeatable signal, and reduce unwanted harmonics on an arbitrary signal.

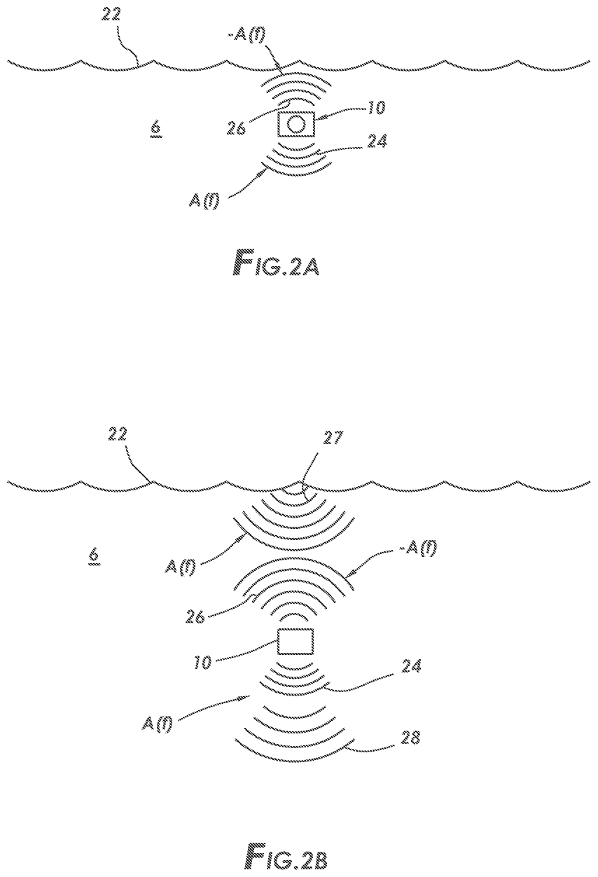

FIG. 2A illustrates generation of acoustic waves in body of water 6 by the dipole source 10 in accordance with example embodiments. The dipole source 10 may be positioned below a water surface 22. The dipole source 10 may be operated in body of water 6 to generate acoustic waves with opposite polarity, illustrated on FIG. 2A as down-going wave 24 and up-going wave 26 with opposite polarity. Down-going wave 24 may be at a low frequency. In some embodiments, down-going wave 24 may have a frequency between about 0.1 Hz and about 100 Hz, alternatively, between about 0.1 Hz and about 10 Hz, and alternatively, between about 0.1 Hz and about 5 Hz. Down-going wave 24 may have a frequency spectrum of A(f), while up-going wave 26 may be created with reverse polarity, or frequency spectrum of −A(f). Up-going wave 26 may also be at a low frequency. In some embodiments, up-going wave 26 may have a frequency between about 0.1 Hz and about 100 Hz, alternatively, between about 0.1 Hz and about 10 Hz, and alternatively, between about 0.1 Hz and about 5 Hz. As illustrated by FIG. 2B, up-going wave 26 may be reflected off the water surface 22 to provide reflected wave 27, which may then have the same polarity, A(f), as the down-going wave 24. At low frequencies, these two down-going waves (e.g., down-going wave 24 and reflected wave 27) may combine substantially in-phase to provide a composite wave 28 that is down going. In some embodiments, the dipole source 10 may be positioned close to the water surface 22, for example, at a distance of about 10% or less of the wavelength of the up-going wave 26 or, alternatively, at a distance of about 5% or less of the wavelength of the up-going wave 26. The amplitude spectrum radiated by the marine seismic vibrator 10 may be modulated by the amplitude of a cosine function. Therefore, the resulting composite wave 28 may retain amplitudes at low frequencies, since the low frequencies may not be attenuated by destructive interference.

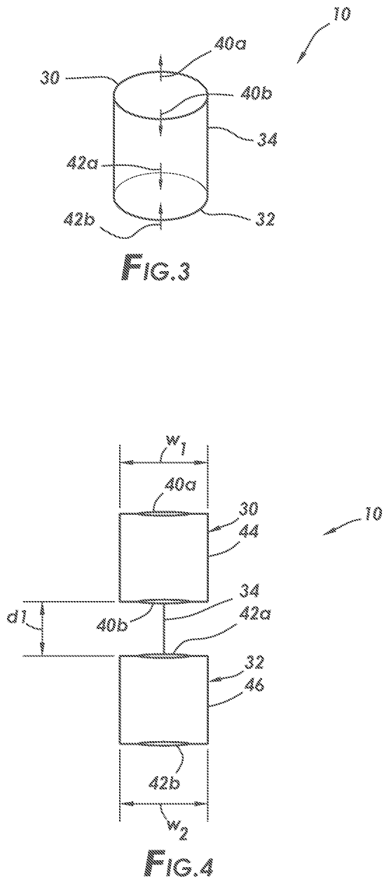

FIG. 3 illustrates an example of dipole source 10. In the illustrated embodiment, dipole source 10 may include a first marine seismic vibrator 30 and a second marine seismic vibrator 32. The relative position of the first marine seismic vibrator 30 and the second marine seismic vibrator 32 may be fixed, for example, the first marine seismic vibrator 30 and the second marine seismic vibrator 32 may be fixed to one another. Any suitable technique may be used for fixing the first marine seismic vibrator 30 and the second marine seismic vibrator 32 to one another. For example, a fixture 34 may be used to interconnect the first marine seismic vibrator 30 and the second marine seismic vibrator 32 fixing them to one another, which may be a rod, bar, frame, or other suitable fixture for interconnecting the first marine seismic vibrator 30 and the second marine seismic vibrator 32. As illustrated, the first marine seismic vibrator 30 may be fixed above the second marine seismic vibrator 32 in a towing configuration. In this manner, the first marine seismic vibrator 30 may be positioned above the second marine seismic vibrator 32 when towed, for example, through the body of water 6 on FIG. 1.

The first marine seismic vibrator 30 and the second marine seismic vibrator 32 may be any suitable marine vibrator. As compared to impulsive-type sources (e.g., air guns) that transmit energy during a very limited amount of time, marine vibrators release energy over an extended period of time. Marine vibrators typically generate vibrations through a range of frequencies in a pattern known as a “sweep” or “chirp.” Marine vibrators generate acoustic energy (or sound) through vibration of sound-radiating surfaces. Suitable marine vibrators may include hydraulically powered sources, flextensional shell sources, piston plate vibrators, and bender sources (e.g., piezoelectric benders). Typical flextensional shell source may be based on the principle of changes in volume in a vibrating, generally elliptic shell. When the longer, major axis of an ellipse is set into vibration by a driving force (e.g., an electro-dynamic driver), the length of the shorter, minor axis will also vibrate, but with a much larger amplitude. Other mechanisms may be also be used for driving the flextensional shell sources. Piston plate sources may be based on generation of acoustic energy through oscillation of a piston plate. Bender source may be based on generation of acoustic energy through mechanical vibration of a flexible disc, also referred to as a flexural disc projector. A bender source may employ one or more piezoelectric elements such that vibration of the flexible disc may be driven piezoelectric distortion based on electrical energy applied to the piezoelectric element. Other mechanism may also be used for driving the bender source.

At least one embodiment includes operation of the dipole source 10 with the first marine seismic vibrator 30 and the second marine seismic vibrator 32 operating substantially 180° out of phase with one another. It should be understood that “substantially 180° out of phase” refers to operation within +/−5% of 180° out of phase, for example, between 1710 and 189° out of phase. In a particular embodiment, the first marine seismic vibrator 30 and the second marine seismic vibrator 32 may operate within +/−1% of 180° out of phase 180° out of phase with one another, for example, between 178.2° and 181.8° out of phase with one another. As illustrated, operation substantially 180° out of phase may include two or more sound radiating surfaces 40a, 40b of the first marine seismic vibrator 30 to be operating out of phase with two or more sound radiating surfaces 42a, 42b of the second marine seismic vibrator 32. For example, the two or more sound radiating surfaces 40a, 40b of the first marine seismic vibrator 30 may flex inward while the two or more sound radiating surfaces 42a, 42b of the second marine seismic vibrator 32 flex outward, as shown by the arrows on FIG. 3. It should be understood that any waves generated by the adjacent surfaces (e.g., lower sound radiating surface 40b and upper sound radiating surface 42a) should cancel one another out as being of opposite polarity.

FIG. 4 illustrates another example of dipole source 10. As illustrated, the dipole source 10 may include a first marine seismic vibrator 30 and a second marine seismic vibrator 32 fixed to one another by a fixture 34. In the illustrated embodiment, the first marine seismic vibrator 30 may include two or more sound radiating surfaces 40a, 40b, and the second marine seismic vibrator 32 also may include two or more sound radiating surfaces 42a, 42b. The two or more sound radiating surfaces 40a, 40b of the first marine seismic vibrator 30 may be referred to collectively as two or more sound radiating surfaces 40a, 40b and individually as upper sound radiating surface 40a and lower sound radiating surface 40b. The two or more sound radiating surfaces 42a, 42b of the second marine seismic vibrator 32 may be referred to collectively as two or more sound radiating surfaces 42a, 42b and individually as upper sound radiating surface 42a and lower sound radiating surface 42b. The upper sound radiating surface 42a of the second marine seismic vibrator 32 may be spaced a distance di from the lower sound radiating surface 40b of the first marine seismic vibrator 30. The distance di may be any suitable distance, for example, the distance di, may be less than the smaller of the width w₁ of the first marine seismic vibrator 30 and the width w₂ of the second marine seismic vibrator 32. In some embodiments, the selected distance di may be as small as possible without touching of the upper sound radiating surface 42a of the second marine seismic vibrator and the lower sound radiating surface 40b of the first marine seismic vibrator 30. For example, the distance di may range from a few centimeters to 1 meter, for example, about 10 centimeters to about 1 meter. Positioning the first marine seismic vibrator 30 and the second marine seismic vibrator 32 close to one another should enable more effective cancelling out of the additional down-going waves 36 and additional up-going waves 38 (e.g., shown on FIG. 3).

In some embodiments, the first marine seismic vibrator 30 and the second marine seismic vibrator 32 may include respective first body 44 and second body 46 that supports and positions the respective two or more sound radiating surfaces 40, 42. For example, the first body 44 of the first marine seismic vibrator 30 may support and position the two or more sound radiating surfaces 40. By way of further example, the second body 46 of the second marine seismic vibrator 32 may support and position the two or more sound radiating surfaces 42. The two or more sound radiating surfaces 40a, 40b of the first marine seismic vibrator 30 and the two or more sound radiating surfaces 42a, 42b of the second marine seismic vibrator 32 may include any suitable surface for use in a marine vibrator that can vibrate and generate acoustic energy, including, but not limited to, a flextensional shell portion, a piston plate, and a flexible disc, among others.

The particular embodiments disclosed above are illustrative only, as the described embodiments may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. All numbers and ranges disclosed above may vary by some amount. Whenever a numerical range with a lower limit and an upper limit is disclosed, any number and any included range falling within the range are specifically disclosed. Moreover, the indefinite articles “a” or “an,” as used in the claims, are defined herein to mean one or more than one of the element that it introduces. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted for the purposes of understanding this disclosure.

What is claimed is:

1. A marine seismic survey system comprising:
a dipole source comprising:
a first marine seismic vibrator comprising two or more sound radiating surfaces; and
a second marine seismic vibrator comprising two or more sound radiating surfaces, wherein a relative position of the second marine seismic vibrator to the first marine seismic vibrator is fixed with the first marine seismic vibrator positioned above the second marine seismic vibrator in a towing configuration; and
a control system operable to control the dipole source such that the first marine seismic vibrator is operating substantially 180° out of phase with the second marine seismic vibrator.

2. The marine seismic survey system of claim 1, wherein the dipole source further comprises a fixture securing the first marine seismic vibrator to the second marine seismic vibrator.

3. The marine seismic survey system of claim 1, wherein the first marine seismic vibrator and the second marine seismic vibrator are each individually selected from a hydraulically powered source, a flextensional shell source, a piston plate vibrator, or a bender source.

4. The marine seismic survey system of claim 1, wherein the two or more sound radiating surfaces of the first marine seismic vibrator and the two or more sound radiating surfaces of the second marine seismic vibrator each individually comprise a flextensional shell portion.

5. The marine seismic survey system of claim 1, wherein the control system is operable to control the dipole source such that the first marine seismic vibrator operates within about 1% of 180° out of phase with the second marine seismic vibrator.

6. The marine seismic survey system of claim 1, wherein the control system is operable to operate the dipole source at a frequency in a range of from about 0.1 Hz to about 25 Hz.

7. The marine seismic survey system of claim 1, wherein the control system is operable to operate the dipole source at a frequency in a range of from about 0.1 Hz to about 6 Hz.

8. The marine seismic survey system of claim 1, wherein the first marine seismic vibrator and the second marine seismic vibrator are spaced apart such that a lower sound radiating surface of the two or more sound radiating surfaces of the first marine seismic vibrator and an upper sound radiating surface of the two or more sound radiating surfaces of the second marine seismic vibrator are separated by a distance less than a smaller of a width of the first marine seismic vibrator and a width of the second marine seismic vibrator.

9. The marine seismic survey system of claim 1, further comprising a plurality of sensor streamers spaced laterally apart from one another, where each of the sensor streamers comprises seismic sensors at apart locations for generating response signals in response to acoustic energy emitted from the dipole source after interaction with one or more subsurface formations below a water bottom; and a survey vessel that tows the plurality of sensor streamers and the dipole source.

10. A method for marine seismic surveying comprising:
towing a dipole source through a body of water;
generating acoustic energy with a first marine seismic vibrator of the dipole source, the acoustic energy comprising an up-going wave;
reflecting the up-going wave off a surface of the body of water to form a reflected wave;
generating acoustic energy with a second marine seismic vibrator of the dipole source, the acoustic energy comprising a down-going wave with opposite polarity to the up-going wave, wherein the up-going waves of the first marine seismic vibrator; and
combining the reflected wave and the down-going wave substantially in phase.

11. The method of claim 10, wherein the first marine seismic vibrator and the second marine seismic vibrator are controlled such that the first marine seismic vibrator is operating within about 1% of 180° out of phase with the second marine seismic vibrator.

12. The method of claim 10, wherein the dipole source is operated at a frequency in a range of from about 0.1 Hz to about 25 Hz.

13. The method of claim 10, wherein the dipole source is operated at a frequency in a range of from about 0.1 Hz to about 6 Hz.

14. The method of claim 10, wherein the generating acoustic energy with the first marine seismic vibrator and the generating acoustic energy with the second marine seismic vibrator each individually comprises at least one of vibrating a flextensional shell, vibrating one or more piston plates, or flexing one or more bender plates.

15. The method of claim 10, wherein the first marine seismic vibrator and the second marine seismic vibrator are positioned such that down-going waves from the first marine seismic vibrator are cancelled out by up-going waves from the second marine seismic vibrator.

16. The method of claim 10, further generating response signals with one or more seismic sensors towed in the body of water in response to the acoustic energy from the first marine seismic vibrator and the acoustic energy from the second marine seismic vibrator.

17. A method of manufacturing a geophysical data product comprising:
generating acoustic energy with a first marine seismic vibrator of the dipole source, the acoustic energy comprising an up-going wave;
reflecting the up-going wave off a surface of the body of water to form a reflected wave;
generating acoustic energy with a second marine seismic vibrator of the dipole source, the acoustic energy comprising a down-going wave with opposite polarity to the up-going wave, wherein the up-going waves of the first marine seismic vibrator;
combining the reflected wave and the down-going wave substantially in phase;
obtaining geophysical data from measurements of the acoustic energy from the first marine seismic vibrator and the acoustic energy from the second marine seismic vibrator;
processing the geophysical data to produce a seismic image; and
recording the seismic image on a non-transitory, tangible computer-readable medium, thereby creating the geophysical data product.

18. The method of claim 17, wherein dipole source is operated at a frequency in a range of from about 0.1 Hz to about 6 Hz.

19. The method of claim 17, wherein the generating acoustic energy with the first marine seismic vibrator and the generating acoustic energy with the second marine seismic vibrator each individually comprises at least one of vibrating a flextensional shell, vibrating one or more piston plates, or flexing one or more bender plates.

20. The method of claim 17, wherein the first marine seismic vibrator and the second marine seismic vibrator are positioned such that down-going waves from the first marine seismic vibrator are cancelled out by up-going waves from the second marine seismic vibrator.
